(19) United States
(12) Patent Application Publication
(10) Pub. No.: US 2016/0381433 A1
(43) Pub. Date: Dec. 29, 2016

(54) INFORMATION DISTRIBUTION DEVICE, INFORMATION DISTRIBUTION METHOD, AND PROGRAM

(71) Applicant: Panasonic Intellectual Property Management Co., Ltd., Osaka (JP)

(72) Inventor: Sandeep DHUNGANA, Osaka (JP)

(21) Appl. No.: 15/259,589

(22) Filed: Sep. 8, 2016

Related U.S. Application Data
(63) Continuation of application No. PCT/JP2014/006337, filed on Dec. 19, 2014.

(30) Foreign Application Priority Data
Mar. 14, 2014 (JP) 2014-051523

(51) Int. Cl. H04N 21/81; H04N 21/8405; H04N 21/2668; H04N 21/858; H04N 21/466; G06Q 30/02; H04N 21/845

(52) U.S. Cl. CPC H04N 21/812; G06Q 30/0256; G06Q 30/0264; H04N 21/8405; H04N 21/8126; H04N 21/8456; H04N 21/8586; H04N 21/4668; H04N 21/2668

(57) ABSTRACT

An information distribution device of the present disclosure includes: an analysis unit configured to extract a keyword and a reproduction time of the keyword from a text related to content; an advertisement DB (Data Base) configured to store advertisement information in association to one of a plurality of advertisement categories; a determination unit configured to determine a category, from the plurality of advertisement categories, for the keyword; a generation unit configured to extract, from the advertisement DB, advertisement information corresponding to the category determined by the determination unit and configured to generate information content in conjunction with the content such that the extracted advertisement information is reproduced at the reproduction time; and an output unit configured to output the information content.

### BACKGROUND

1. Technical Field

The present disclosure relates to an information distribution device, an information distribution method, and a program for distributing information including an advertisement in conjunction with content.

2. Description of the Related Art

WO 2008/126775 discloses an information recommendation system which recommends information related to video content to a viewer who is watching the video content. The information recommendation system analyses metadata of content and sorts the content into types such as weather, variety, sports, and news, and divides video content including different types into segments.

### SUMMARY

The present disclosure provides an information distribution device, an information distribution method, and a program for distributing content together with information highly related to the content to a viewer at appropriate timing.

An information distribution device of the present disclosure includes: an analysis unit configured to extract a keyword and a display end time of the keyword from a text related to content; an advertisement DB (Data Base) configured to store advertisement information in association to one of a plurality of advertisement categories; a determination unit configured to determine a category, from the plurality of advertisement categories, for the keyword; a generation unit configured to extract, from the advertisement DB, advertisement information corresponding to the category determined by the determination unit and configured to generate information content in conjunction with the content such that a display start time of the extracted advertisement information is set to a time equal to or later than the display end time extracted by the analysis unit; and an output unit configured to output the information content.

The information distribution device of the present disclosure can deliver content together with information highly related to the content to a viewer at appropriate timing.

### BRIEF DESCRIPTION OF DRAWINGS

FIG. 1 is a block diagram of an information distribution system in a first exemplary embodiment;

FIG. 2 is a diagram showing an example of advertisement categories in the first exemplary embodiment;

FIG. 3 is a diagram showing an example of an advertisement DB in the first exemplary embodiment;

FIG. 4 is a diagram showing an example of a registration screen displayed on a registration terminal in the first exemplary embodiment;

FIG. 5 is a flowchart showing how to generate information content in the first exemplary embodiment;

FIG. 6 is a diagram showing an example of a caption text in the first exemplary embodiment;

FIG. 7 is a diagram showing an example of an advertisement display scenario in the first exemplary embodiment;

FIG. 8 is a diagram illustrating an example of information content in the first exemplary embodiment;

FIG. 9 is a diagram illustrating another example of the information content in the first exemplary embodiment;

FIG. 10 is a diagram illustrating how to extract a keyword in an utterance section of a caption text in the first exemplary embodiment;

FIG. 11 is a diagram showing an example of a semantic hierarchical data base in the first exemplary embodiment;

FIG. 12 is a block diagram of an information distribution system of a second exemplary embodiment; and

FIG. 13 is a block diagram of an information distribution system of a third exemplary embodiment.

### DETAILED DESCRIPTION

In the following, exemplary embodiments are described in detail appropriately with reference to the drawings. However, an unnecessarily detailed description is not made in some cases. For example, detailed descriptions on already well-known matters and redundant descriptions on substantially identical configurations are not made in some cases. This is to avoid the following description from being unnecessarily redundant and thus to help those skilled in the art easily understand.

Note that the accompanying drawings and the following description are provided to help those skilled in the art sufficiently understand the present disclosure, and are not intended to limit the subject matter of the claims.

### First Exemplary Embodiment

### [1-1. Configuration of the Information Distribution System]

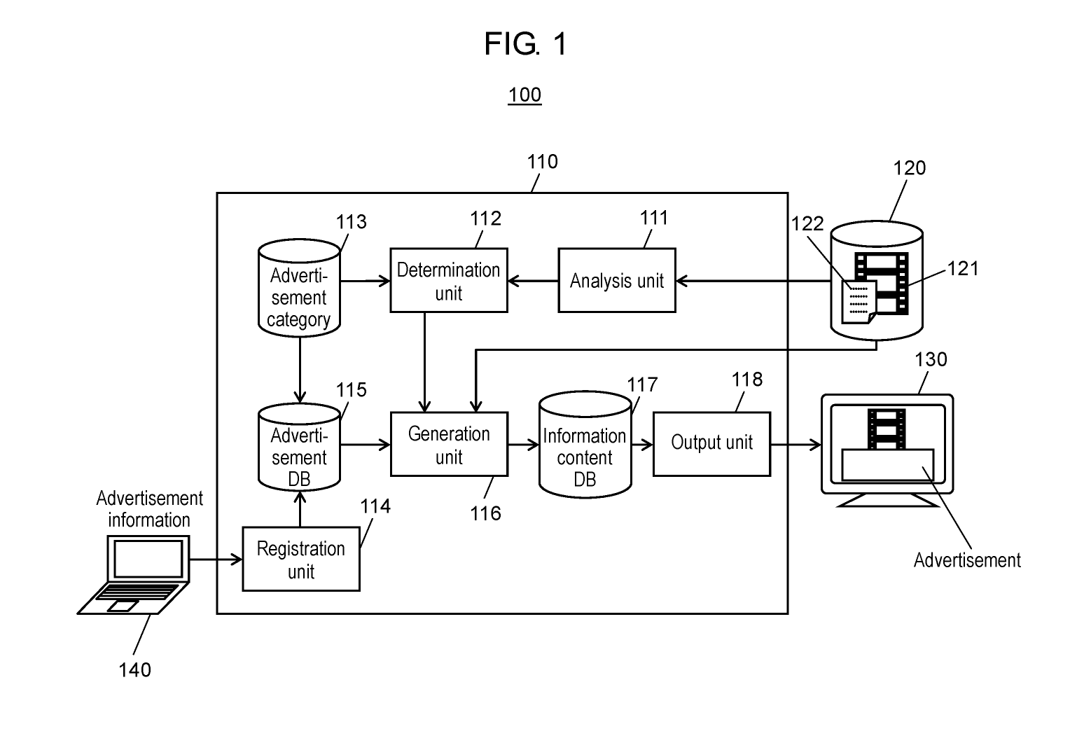

FIG. 1 is a block diagram showing an information distribution system in a first exemplary embodiment. Information distribution system 100 includes information distribution device 110, content server 120, display terminal 130, and registration terminal 140, and these components are connected to one another through a network.

Information distribution device 110 includes analysis unit 111, determination unit 112, advertisement category 113, registration unit 114, advertisement DB (Data Base) 115, generation unit 116, information content DB 117, and output unit 118.

Content server 120 is a server in which content such as a movie is stored, and the content is composed of moving image 121 and caption text 122.

Display terminal 130 is a terminal for a user to view information content generated by information distribution device 110, and is a display device such as a personal computer and a smartphone.

Registration terminal 140 is a terminal for an advertising agent to register advertisement information on information distribution device 110, and is a display device such as a personal computer and a smartphone.

Analysis unit 111 obtains caption text 122 of content from content server 120 which is connected to analysis unit 111 through a network. Analysis unit 111 analyses obtained caption text 122 by a predetermined character number to extract a keyword from caption text 122. Here, the keyword is a characteristic word in caption text 122. Analysis unit 111 further extracts from caption text 122 a display time at which the extracted keyword is displayed. Analysis unit 111 informs determination unit 112 of the extracted keyword and the display time of the keyword.

Advertisement category 113 includes categories to be used to sort advertisement information when an advertising agent registers the advertisement information on advertisement DB 115, and advertisement category 113 is also used to sort the keyword extracted by analysis unit 111.

Determination unit 112 determines a category for the keyword given from analysis unit 111 by using advertisement category 113. Determination unit 112 informs generation unit 116 of the keyword, the display time of the keyword, and the category of the keyword.

Registration unit 114 registers the advertisement information, being input by the advertising agent through registration terminal 140, on advertisement DB 115.

Advertisement DB 115 stores the advertisement information registered by registration unit 114. The registered advertisement information is stored in association to one of the categories in advertisement category 113.

Generation unit 116 generates an advertisement display scenario from the keyword, the display time of the keyword, and the category of the keyword given from determination unit 112 and from the advertisement information stored in advertisement DB 115. Here, the advertisement display scenario is a scenario defined by (i) the advertisement information to be displayed in conjunction with reproduction of the content and (ii) a display time of the advertisement information, where the advertisement information and the display time of the advertisement information are in association to each other. Generation unit 116 registers, on information content DB 117, information content in which the generated advertisement display scenario and the content are in association to each other.

Information content DB 117 is a DB for storing information content in which content in content server 120 and advertisement information to be reproduced in conjunction with the content are related to each other.

Output unit 118 outputs the information content stored in information content DB 117 to display terminal 130 through the network.

### [1-2. Advertisement Category]

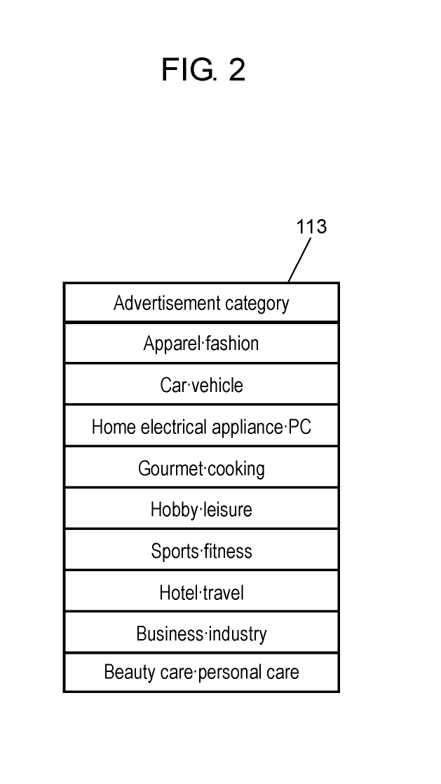

Next, advertisement category 113 will be described in detail. FIG. 2 is a diagram showing an example of advertisement category 113. With reference to FIG. 2, advertisement category 113 includes nine categories of “Apparel•Fashion,” “Car•Vehicle,” “Home Electrical Appliance•PC (Personal Computer),” “Gourmet•Cooking,” “Hobby•Leisure,” “Sports•Fitness,” “Hotel•Travel,” “Business•Industry,” and “Beauty Care•Personal Care.” Using these nine categories, the advertising agent sorts advertisement information when registering the advertisement information on advertisement DB 115, and the advertising agent further uses these nine categories when sorting the keyword extracted by analysis unit 111.

Advertisement category 113 may be previously stored in information distribution device 110, but new categories may be added afterward.

### [1-3. Advertisement DB]

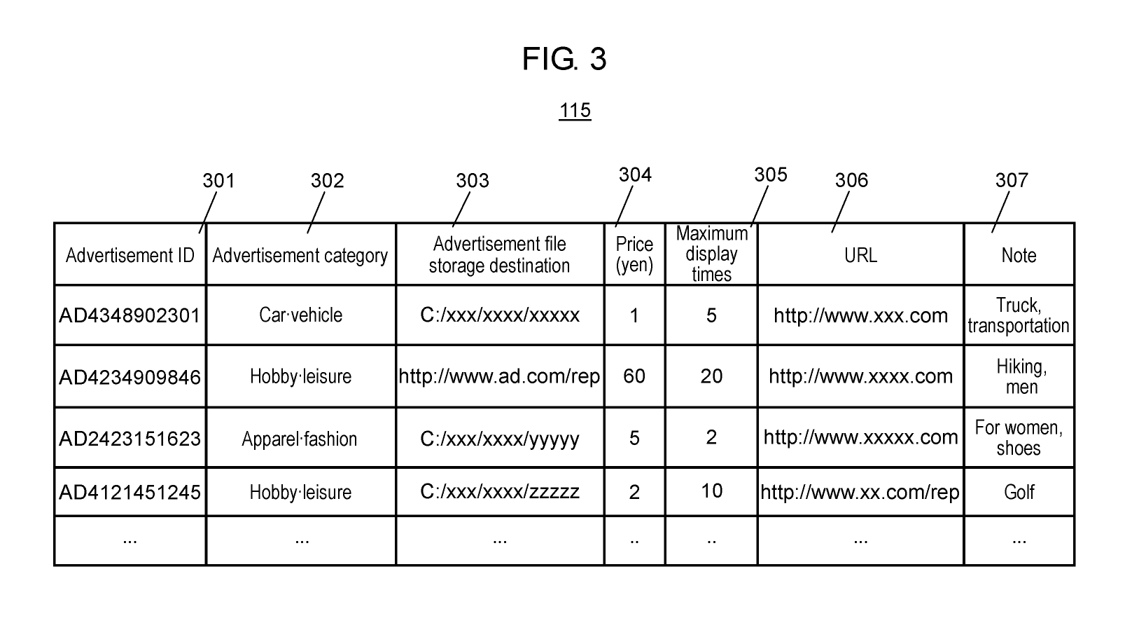

Next, advertisement DB 115 will be described in detail. FIG. 3 is a diagram showing an example of advertisement DB 115. Advertisement DB 115 is information in a form of a data base and stores advertisement information registered by registration unit 114.

Advertisement DB 115 stores at least a set of advertisement ID (IDentification) 301, advertisement category 302 corresponding to advertisement ID 301, advertisement file storage destination 303, price 304, maximum display times 305, URL (Uniform Resource Locator) 306, and note 307.

Advertisement ID 301 is an identifiable ID given at the time of registration to advertisement DB 115.

Advertisement category 302 indicates the category selected from advertisement category 113 by the advertising agent when the advertising agent registers the advertisement information.

Advertisement file storage destination 303 indicates a storage location of data of the advertisement which the advertising agent intends to display. The storage location includes an address on an HDD (Hard Disk Drive) of registration terminal 140 or a URL specifying a location on the internet.

Price 304 indicates an advertisement inserting rate desired by the advertising agent. Price 304 indicates, for example, a CPM (Cost Per Mile) which is a rate for advertisement inserting times of 1,000, and a unit of the rate is yen.

Maximum display times 305 indicates a maximum number of times for which the advertisement is displayed to the same user a day.

URL 306 indicates a URL which is accessed when a user clicks on an advertisement displayed on display terminal 130.

Note 307 indicates more detailed information about advertisement information. Specifically, note 307 indicates information including a more detailed category of the advertisement information, targeted customers of the advertisement information, a display starting date of the advertisement information, and a display period of the advertisement information.

Note that the data structure of advertisement DB 115 is not limited to the above described structure. For example, note 307 does not have to be totally managed as note 307, and may be separately managed as other items.

### [1-4. How to Register the Advertisement Information]

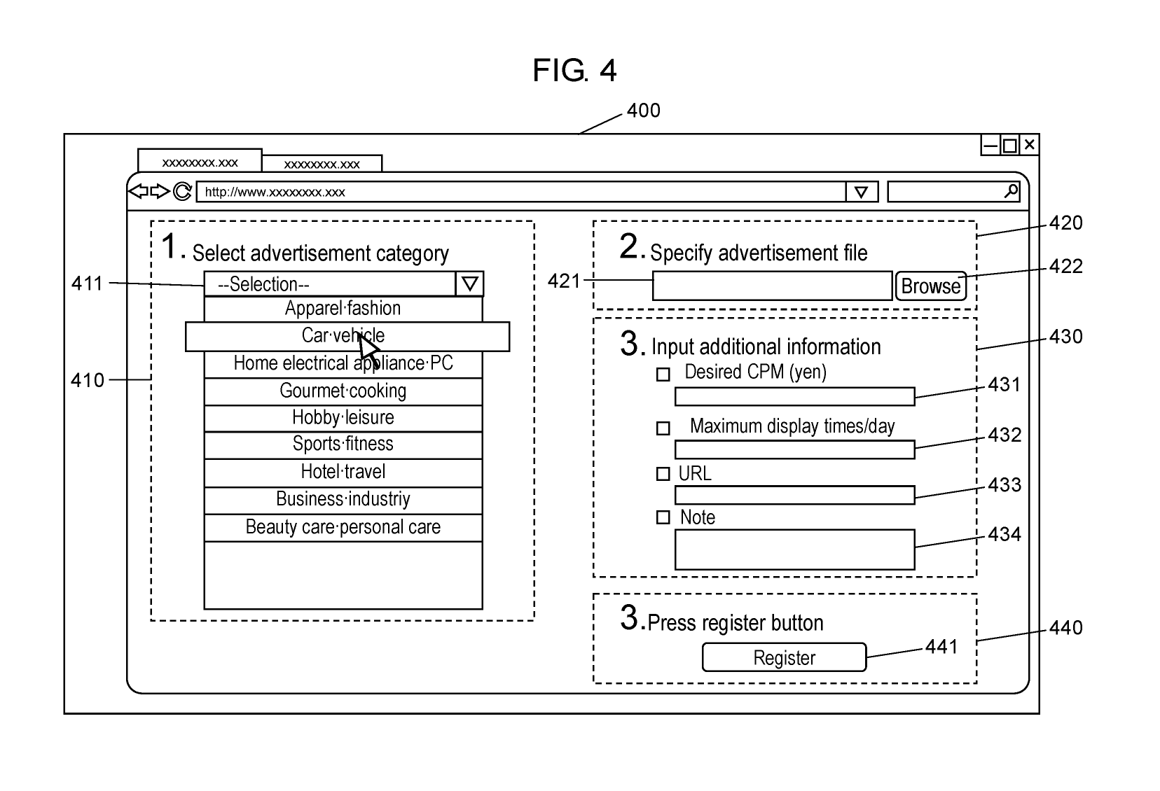

Next, it will be described in detail how to register the advertisement information. The advertisement information is registered on advertisement DB 115 of information distribution device 110 by using registration terminal 140. FIG. 4 is a diagram showing an example of a registration screen displayed on registration terminal 140. The registration screen is a user interface to be used to register the advertisement information on advertisement DB 115 of information distribution device 110. With reference to FIG. 4, registration screen 400 is composed of advertisement category selection field 410, advertisement file specification field 420, additional information input field 430, and registration field 440.

The advertisement information selected or input on registration screen 400 is the information to be registered on advertisement DB 115 of information distribution device 110, in association to advertisement ID 301.

Advertisement category selection field 410 contains pull-down menu 411 so that the category of the advertisement information to be registered can be selected from the categories stored in advertisement category 113. The selected category is stored as advertisement category 302 of advertisement DB 115.

Advertisement file specification field 420 contains text box 421 and browse button 422. Text box 421 is a widget for the advertising agent of registration terminal 140 to input a character string. Browse button 422 is a widget to select a file by pressing the button. When the button is clicked, a file selection dialogue is displayed, and when an arbitrary file is selected from the dialogue, a name of the selected file is displayed in text box 421. The location at which the data of the advertisement desired to be displayed are stored, for example, an address on the HDD of registration terminal 140 or an internet URL, is input, in characters, in text box 421, or the location at which the data of the advertisement desired to be displayed are stored is selected by clicking browse button 422. The location, at which the data of the advertisement desired to be displayed are stored, which is input in text box 421 or selected is stored as advertisement file storage destination 303 in advertisement DB 115.

Additional information input field 430 contains text boxes 431, 432, 433, and 434. Text box 431 is used to input an advertisement inserting rate. The advertisement inserting rate to be input is, for example, the CPM (Cost Per Mile) which is the rate for advertisement inserting times of 1,000. The advertisement inserting rate input in text box 431 is stored as price 304 in advertisement DB 115. Text box 432 is used to input the maximum number of times for which the advertisement is displayed to the same user a day. A number of times input is stored as maximum display times 305 in advertisement DB 115. Text box 433 is used to input a URL which is accessed when the user clicks on the advertisement displayed on display terminal 130. The URL input is stored as URL 306 in advertisement DB 115. Text box 434 is used to input more detailed information of the advertisement information. Specifically, the more detailed information includes the more detailed category of the advertisement information, the targeted customers of the advertisement information, the display starting date of the advertisement information, and the display period of the advertisement information. The information input is stored as note 307 in advertisement DB 115.

Registration field 440 contains registration button 441. Registration button 441 is supposed to be pressed down by the advertising agent after the advertising agent inputs in the three fields of advertisement category selection field 410, advertisement file specification field 420, and additional information input field 430. When the advertising agent presses down registration button 441, the input content is stored as the advertisement information in advertisement DB 115, in association to advertisement ID 301.

### [1-5. First Example of How to Generate the Information Content]

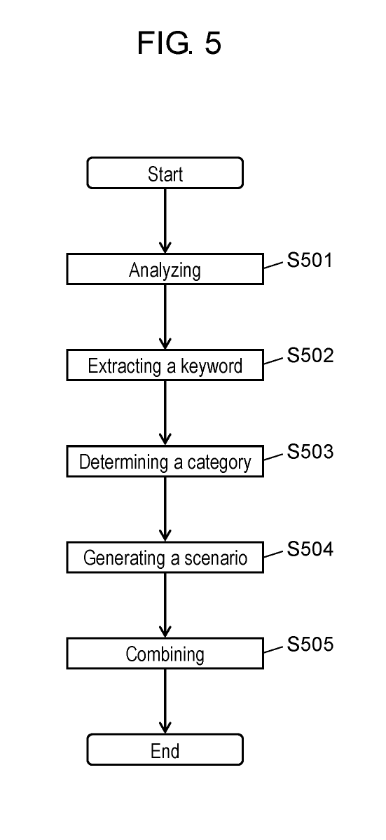

Next, it will be described in detail how to generate the information content in information distribution device 110. The information content is content stored in information content DB 117 and is content in which the content obtained from content server 120 is related to the advertisement display scenario indicating a reproduction order of the advertisement information to be reproduced in linking with the obtained content. FIG. 5 is a flowchart showing how to generate the information content in the first exemplary embodiment.

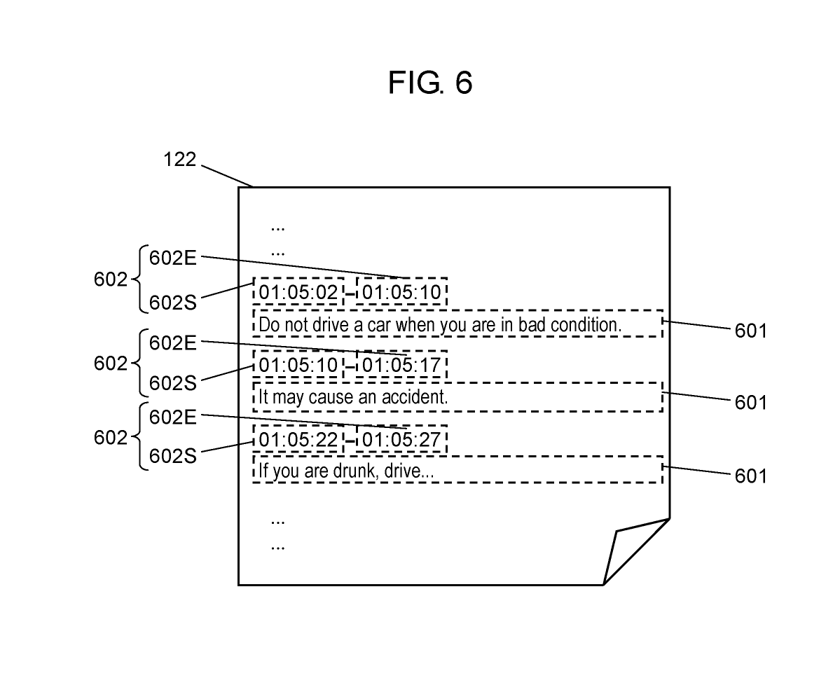

First, caption text 122 stored in content server 120 will be described. FIG. 6 is a diagram showing an example of caption text 122 in the first exemplary embodiment. Caption text 122 has at least a set of sentence 601, and display time 602 corresponding to sentence 601. Display time 602 is composed of display start time 602S and display end time 602E. With reference to FIG. 6, in detail, display start time 602S indicates a lapse time from the start of reproducing moving image 121, and display end time 602E indicates a lapse time from the start of reproducing moving image 121. With reference to FIG. 6, for example, with respect to sentence 601 “Do not drive a car when you are in bad condition,” display start time 602S of display time 602 is made to correspond to “01:05:02”, namely one hour, five minutes, and two seconds, and display end time 602E is made to correspond to “01:05:10”, namely one hour, five minutes, and 10 seconds.

Note that, in the format of caption text 122 of the present exemplary embodiment, a predetermined amount of text such as a sentence and a paragraph only has to correspond to the display time of the text, and the exemplary embodiment is not limited to a sentence.

The flowchart of FIG. 5 will be described.

In step S501, analysis unit 111 of information distribution device 110 obtains caption text 122 of target content from content server 120 and divides each sentence 601 into words. As a method for dividing a sentence into words, the Morphological Analysis method, which is one of basic technologies for natural language processing, is used, for example. For example, when sentence 601 “Do not drive a car when you are in bad condition” is divided into words, sentence 601 is divided into 11 words of “do,” “not,” “drive,” “a,” “car,” “when,” “you,” “are,” “in,” “bad,” and “condition.”

In step S502, analysis unit 111 extracts a keyword from the divided 11 words. As a method for extracting the keyword, the TF-IDF (Term Frequency-Inverse Document Frequency) method, in which words are weighted in a sentence, is used, for example. By using the TF-IDF method, the word “car” is extracted as a keyword from the 11 words. Analysis unit 111 informs determination unit 112 of the extracted keyword “car” and “01:05:10,” which is display end time 602E.

In step S503, when receiving the keyword “car” and “01:05:10,” which is display end time 602E, from analysis unit 111, determination unit 112 determines a category which matches the keyword “car” from the categories stored in advertisement category 113. For the determination of category, a method is used in which the category to which the keyword belongs is determined by using data learned by machine learning, for example. Determination unit 112 determines that the category matching the keyword “car” is “Car•Vehicle.” Determination unit 112 informs generation unit 116 of the keyword “car,” “01:05:10,” which is display end time 602E, and the category “Car•Vehicle.”

In step S504, when generation unit 116 is informed of the keyword “car,” “01:05:10,” which is display end time 602E, and the category “Car•Vehicle,” generation unit 116 generates the advertisement display scenario.

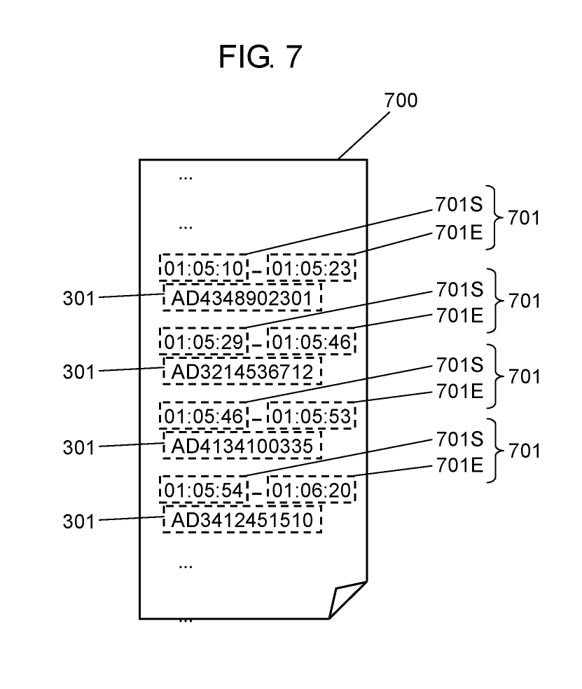

Here, an advertisement display scenario will be described in detail. FIG. 7 is a diagram showing an example of an advertisement display scenario of the first exemplary embodiment. With reference to FIG. 7, advertisement display scenario 700 has at least a set of display time 701 for displaying advertisement information and advertisement ID 301 for specifying the advertisement information to be displayed. Display time 701 is composed of display start time 701S and display end time 701E. Display start time 701S indicates a lapse time from the start of reproducing moving image 121, and display end time 701E indicates a lapse time from the start of reproducing moving image 121.

Generation unit 116 searches advertisement DB 115 for advertisement category 302 which matches the category “Car•Vehicle” given from determination unit 112. In advertisement DB 115 of FIG. 3, advertisement information whose advertisement category 302 matches the category “Car•Vehicle” is the advertisement information having advertisement ID 301 of “AD4348902301.” Generation unit 116 sets display start time 701S of advertisement display scenario 700 to “01:05:10,” which is display end time 602E given from determination unit 112. Further, generation unit 116 set display end time 701E to an arbitrary time. Display end time 701E may be determined based on price 304 or note 307 corresponding to advertisement ID 301 or may be adjusted depending on the display start time of the next advertisement information. With reference to FIG. 7, display end time 701E is set to “01:05:23,” which indicates one hour, five minutes, and 23 seconds, for example.

If advertisement DB 115 contains a plurality of advertisement IDs 301 which match the category “CarVehicle,” the advertisement information to be displayed can be determined in consideration of price 304, maximum display times 305, note 307, and the like.

Generation unit 116 adds, to advertisement display scenario 700, advertisement ID 301 “AD4348902301,” display start time 701S “01:05:10,” and display end time 701E “01:05:23” of the determined advertisement information.

The process of steps S501 to S504 is performed on all of sentences 601 in caption text 122 to determine the advertisement information to be displayed, and advertisement display scenario 700 is thus generated.

In step S505, next, generation unit 116 obtains target content from content server 120. Generation unit 116 obtains data of the advertisement to be displayed from advertisement file storage destination 303 “C:/xxx/xxxx/xxxxx” in advertisement DB 115 corresponding to advertisement ID 301 “AD4348902301” of advertisement display scenario 700, and generation unit 116 makes the content correspond to the advertisement information by setting the display time of the data of the obtained advertisement such that display start time 701S is “01:05:10” and such that display end time 701E is “01:05:23,” thereby generating the information content. Generation unit 116 registers the generated information content on information content DB 117.

Regarding the information content, if the content obtained from content server 120 contains compressed moving image 121 and caption text 122, the content may get uncompressed first. Next, the advertisement information may be multiplexed to the content, and then the content may be compressed to make the information content. Alternatively, the uncompressed content may be made to be related to the advertisement information without being compressed.

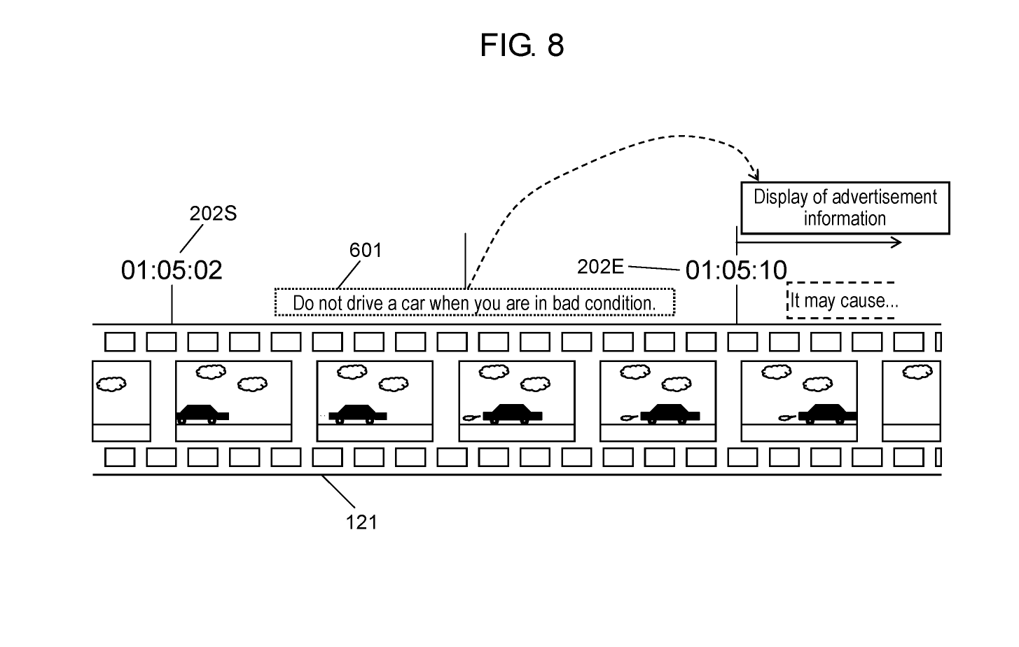

FIG. 8 is a diagram illustrating an example of the information content in the first exemplary embodiment. With reference to FIG. 8, in moving image 121, in the period from the time of one hour, five minutes, and two seconds after the display start time of moving image 121 to the time of one hour, five minutes, 10 seconds, sentence 601 “Do not drive a car when you are in bad condition” in caption text 122 is displayed. Along with this caption, in moving image 121, video of a car travelling from left to right is displayed. In addition, the advertisement information corresponding to sentence 601 is displayed from the time of one hour, five minutes, and 10 seconds.

As described above, the display start time of the advertisement information corresponding to the keyword “car” is set to a time equal to or later than the display end time of the sentence containing the keyword. This can prevent the viewer from knowing beforehand a matter in the content from the displayed advertisement information.

### [1-6. Second Example of How to Generate the Information Content]

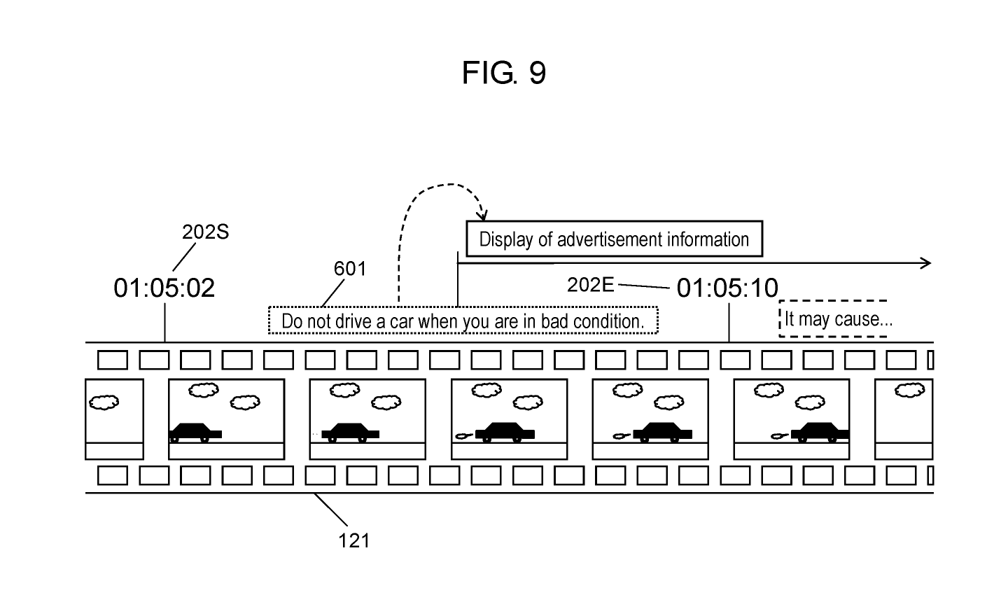

The display start time of the advertisement information with respect to the content does not have to be display end time 602E of sentence 601 in caption text 122 from which the keyword is extracted. FIG. 9 is a diagram illustrating another example of the information content in the first exemplary embodiment.

As shown in FIG. 9, it is also possible to start to display the advertisement information immediately after the keyword “car” of sentence 601 in caption text 122 is extracted.

Analysis unit 111 makes a calculation by fragmenting sentence 601, based on display start time 602S and display end time 602E of sentence 601, then determines the keyword “car” display end time to be “01:05:06,” for example, and informs determination unit 112 of this time. This can prevent the viewer from knowing beforehand the matter of the content, and in addition, can provide the content and the advertisement information in a conjunction manner, to the user at the most appropriate timing.

### [1-7. How to Extract the Keyword]

Next, it will be described in detail how to extract the keyword, which is described in step S502 of FIG. 5. The TF-IDF method, which is a method for extracting a keyword from a plurality of words and in which words are weighted in a sentence, is expressed by the following equation, for example.

$$tfidf = ( 1 + log ( \frac{n}{N} ) ) \times log \frac{D}{d} \qquad Equation 1$$

where:

tfidf is a degree of importance of a word;

n is a frequency of the word in a scene;

N is a total number of the words in the scene;

d is a number of scenes containing the word;

D is a total number of scenes in a whole moving image; and

the scene is an utterance section in a caption text.

Equation 1 converts a degree of importance of a word into a numerical value by calculating, with respect to any one word, a product of (i) an appearance frequency in a text having a certain amount of words such as sentence 601 which includes the word and (ii) an inverse of an appearance frequency in whole caption text 122.

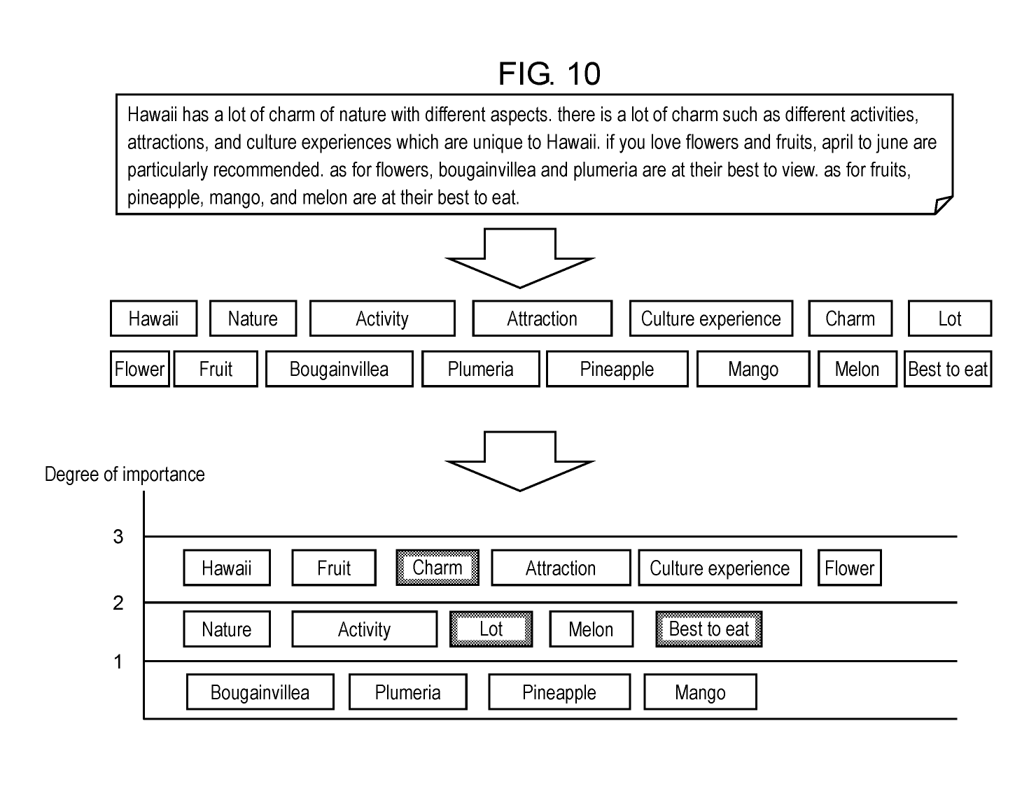

FIG. 10 is a diagram illustrating how words are extracted in an utterance section of caption text 122. With reference to FIG. 10, words are extracted from the text “Hawaii has a lot of charm of nature with different aspects. There is a lot of charm such as different activities, attractions, and culture experiences which are unique to Hawaii. If you love flowers and fruits, April to June are particularly recommended. As for flowers, bougainvillea and plumeria are at their best to view. As for fruits, pineapple, mango, and melon are at their best to eat,” which is an example of the utterance section. The extracted words are “Hawaii,” “nature,” “activity,” “attraction,” “culture experience,” “charm,” “lot,” “flower” “fruit,” “bougainvillea,” “plumeria,” “pineapple,” “mango,” “melon,” and “best to eat.” With respect to these extracted words, the degree of importance of each word is calculated by the TF-IDF method. The calculated results are sorted into degrees of importance 1 to 3. The degree of importance having a larger value is higher. As the words having the degree of importance 3, there are extracted the six words of “Hawaii,” “fruit,” “charm,” “attraction,” “culture experience,” and “flower”; however, it is impossible to determine which word should be the keyword. This is because each word appears once or twice in the utterance section so that the frequency of the words is not reflected in the TF-IDF method. In addition, the extracted words include the words “charm,” “lot,” and “best to eat,” which are difficult to be directly related to the advertisement categories.

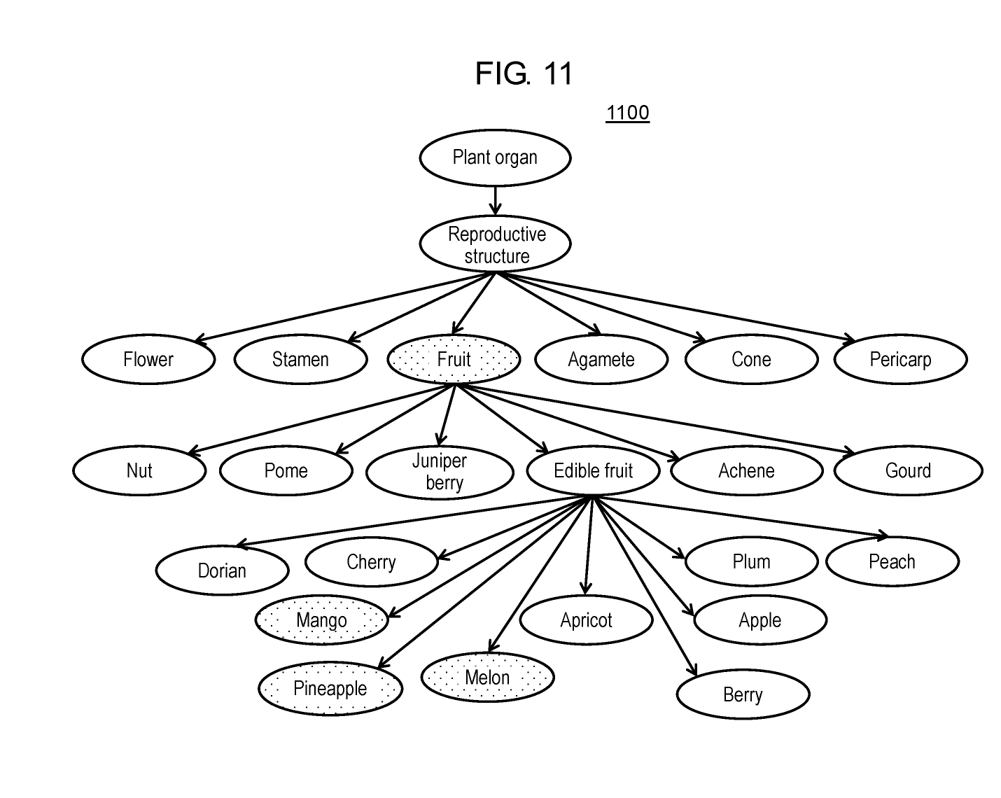

FIG. 11 is a diagram showing an example of a semantic hierarchical data base. The semantic hierarchical data base has a structure in which words are sorted into groups of synonyms and which is defined by relationships on the basis of higher levels, lower levels, families, and parts; thus, the structure is a semantic hierarchical structure on the basis of human recognition. With reference to FIG. 11, semantic hierarchical data base 1100 has a hierarchical structure, and in the structure there is “plant organ” as the highest-level word; at the lower level of the “plant organ” is “reproductive structure”; and at the lower level of “reproductive structure” are “flower,” “stamen,” “fruit,” “agamete,” “cone, ” and “pericarp.” For example, the words “mango,” “pineapple,” and “melon” extracted from the utterance section of FIG. 10 belong to the group of “plant organ,” and it can be said that “mango,” “pineapple,” and “melon” have a strong relationship to the higher level “edible fruit” and the even higher level “fruit.” The extracted wards as a whole are subjected to weighting by using the TF-IDF method, as a word “fruit,” for example. The weighting is performed, for example, in such a manner that (i) a TF-IDF value calculated for each word of FIG. 10 is multiplied by (ii) a value obtained by dividing (a) a number of words having the same higher-level word as the each word by (b) a number of words contained in the caption text. Alternatively, the weighting may be performed after each word extracted from the caption text is converted into its higher-level word. For example, in the example of FIG. 10, the words “melon,” “pineapple,” and “mango” are replaced by their higher-level word “edible fruit” to calculate the TF-IDF value. In this way, the frequencies of words in the TF-IDF method are reflected. In addition, regarding the words “charm,” “lot,” and “best to eat,” which are difficult to be directly related to the advertisement categories, it is checked, by investigating their relationship by using the semantic hierarchical data base, whether the words as a whole can be represented by a higher-level word, and if the words cannot be put together into a higher-level word, each word is treated as an individual word; thus, the degree of importance of each word is determined to be low on the basis of the weighting by the TF-IDF method, whereby each word is not extracted as a keyword.

As described above, the keyword is extracted by performing the weighting, in terms of degree of importance, by the TF-IDF method.

### [1-8. Advantageous Effects, etc.]

As described above, an information distribution device of the present exemplary embodiment includes: an analysis unit configured to extract a keyword and a display end time of the keyword from a text related to content; an advertisement DB (Data Base) configured to store advertisement information in association to one of a plurality of advertisement categories; a determination unit configured to determine a category, from the plurality of advertisement categories, for the keyword; a generation unit configured to extract, from the advertisement DB, advertisement information corresponding to the category determined by the determination unit and configured to generate information content in conjunction with the content by setting a display start time of the extracted advertisement information to a time equal to or later than the display end time extracted by the analysis unit; and an output unit configured to output the information content.

This arrangement makes it possible to display advertisement information highly related to content at appropriate timing, based on a display time at which a keyword is output, and thus to prevent the viewer from knowing beforehand a matter in the content.

In the present exemplary embodiment, the description is made by using the content composed of the moving image and the caption text; however, the present disclosure is not limited to this content. As the content, it is also possible to use a moving image such as a movie and news containing meta-information from which text information based on a reproduction time can be extracted, and in addition, voice and karaoke can also be used. Here, the meta-information represents text information including a caption text, an information telop, and a lyric, and represents binary data such as GPS (Global Positioning System) data indicating positional information.

In the configuration of the present exemplary embodiment, the information content is generated by the information distribution device; however the present disclosure is not limited to this configuration. For example, the information distribution device may generate only the advertisement display scenario. Another configuration may be made such that, when the content is reproduced in the display terminal, the advertisement display scenario and the advertisement information of the advertisement display scenario are obtained from the information distribution device and that the content corresponding to the advertisement display scenario is obtained from content server 120.

In the present exemplary embodiment, the TF-IDF method is used as a method for extracting a keyword. However, the method for extracting the keyword is not limited to the TF-IDF method. For example, a method using a concept dictionary may be used. This method uses the concept dictionary to calculate similarity of the categories of the advertisement, thereby extracting a word having high similarity as a keyword.

Note that, in the present exemplary embodiment, the category is determined by a method in which the category to which a keyword belongs is determined by using learned data made by machine learning. However, another method may be used. For example, a method using a concept dictionary may be used. In this method, the concept dictionary is used to calculate similarity to the keyword, thereby extracting a category having high similarity.

### Second Exemplary Embodiment

Next, an information distribution system in a second exemplary embodiment will be described. In the present exemplary embodiment, the difference from the first exemplary embodiment is mainly described, and redundant components are assigned the same reference numerals and are not described. In the present exemplary embodiment, description is made in a case that the content is audio content.

### [2-1. Configuration of the Information Distribution System]

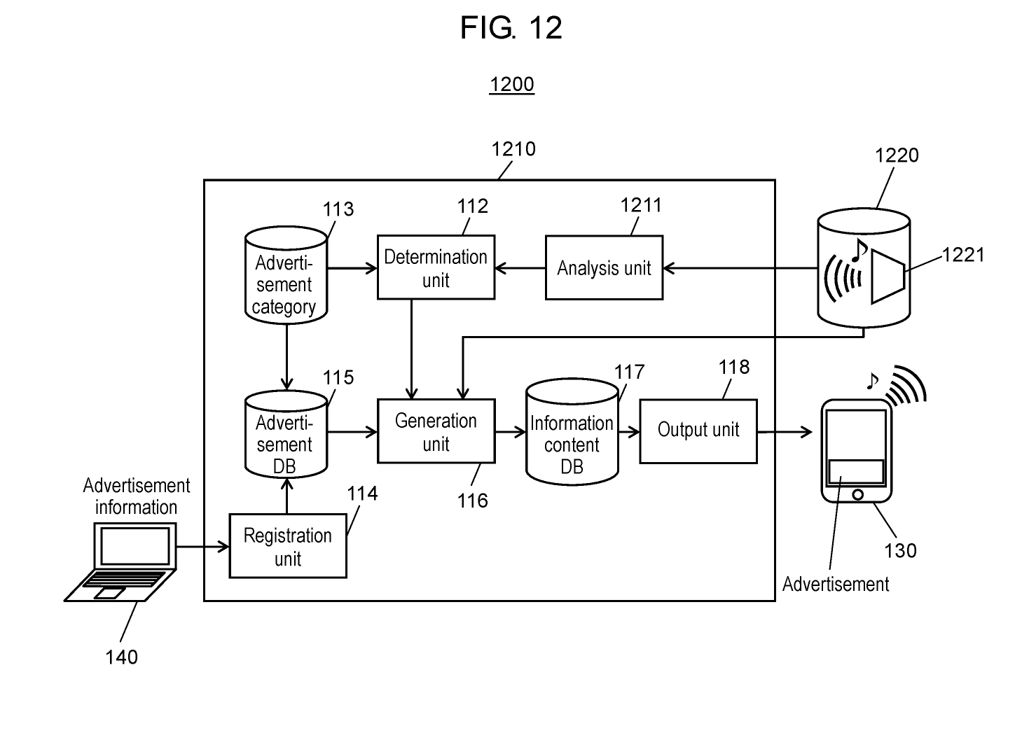

FIG. 12 is a block diagram showing an information distribution system in the second exemplary embodiment.

In the present exemplary embodiment, description is made using audio content capable of being streamed. Here, the audio content includes music, a song, a talk, a speech, and the like.

Information distribution system 1200 includes information distribution device 1210, content server 1220, display terminal 130, and registration terminal 140, and these components are connected to one another through a network.

Information distribution device 1210 includes analysis unit 1211, determination unit 112, advertisement category 113, registration unit 114, advertisement DB 115, generation unit 116, information content DB 117, and output unit 118.

Content server 1220 is a server in which audio content 1221 is stored.

Display terminal 130 is a terminal on which a user listens to information content generated by information distribution device 110, and is a display device such as a personal computer and a smartphone.

Registration terminal 140 is a terminal with which an advertising agent registers the advertisement information to information distribution device 110, and is a display device such as a personal computer and a smartphone.

In information distribution system 1200, what is different from information distribution system 100 described with reference to FIG. 1 is that audio content 1221 is stored in content server 1220, that analysis unit 1211 of information distribution device 1210 is different, and that the information content to be displayed on display terminal 130 is audio content 1221 and advertisement information in conjunction with audio content 1221.

Analysis unit 1211 obtains audio content 1221 from content server 1220 connected through the network. Analysis unit 1211 converts obtained audio content 1221 into a text. To convert audio content 1221 into the text, a speech recognition technology is used. Analysis unit 1211 extracts a keyword from the converted text. Here, the keyword is a characteristic word in the text. Analysis unit 1211 further extracts, as a display time, a reproduction time at which the voice corresponding to the extracted keyword is reproduced. Analysis unit 1211 informs determination unit 112 of the extracted keyword and the display time of the keyword.

Output unit 118 outputs the information content stored in information content DB 117 to display terminal 130 through the network. The information content may be reproduced on display terminal 130 after download of the information content is completed, or may be reproduced in a streaming manner in which the information content is reproduced while the information content is being downloaded.

### [2-2. Advantageous Effect]

As described above, an information distribution device of the present exemplary embodiment includes: an analysis unit configured to extract a keyword and a display end time of the keyword from a text related to content; an advertisement DB (Data Base) configured to store advertisement information in association to one of a plurality of advertisement categories; a determination unit configured to determine a category, from the plurality of advertisement categories, for the keyword; a generation unit configured to extract, from the advertisement DB, advertisement information corresponding to the category determined by the determination unit and configured to generate information content in conjunction with the content by setting a display start time of the extracted advertisement information to a time equal to or later than the display end time extracted by the analysis unit; and an output unit configured to output the information content. Here, the content is audio content, and analysis unit extracts a text from the audio content and extracts, from the extracted text, a keyword and a reproduction time of the keyword.

With this arrangement, the audio content is converted into the text, and the keyword and the display time of the keyword are obtained from the converted text. Thus, it is possible to display the advertisement information highly related to the audio content at appropriate timing, based on the display time at which the keyword is output.

### Third Exemplary Embodiment

Next, an information distribution system in a third exemplary embodiment will be described. In the description, the difference from the first exemplary embodiment and the second exemplary embodiment is mainly described, and redundant components are assigned the same reference numerals and are not described. In the present exemplary embodiment, description is made in a case that a real time speech in a lecture hall or the like, as content, is used as the audio content.

Note that, the content may include not only the case of audio content such as a real-time speech, but also the case of a content which is a text being generated in real-time by a message exchange software or the like, and in addition, the content may include the case of audio content being streamed.

### [3-1. Configuration of the Information Distribution System]

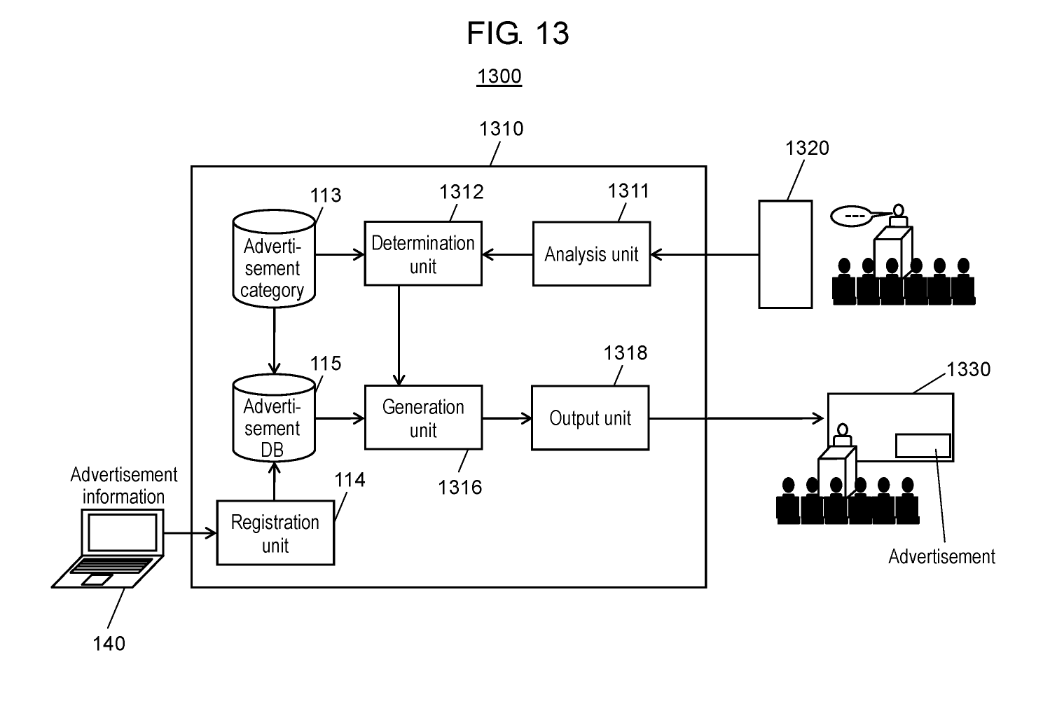

FIG. 13 is a block diagram showing an information distribution system of the third exemplary embodiment.

Information distribution system 1300 includes, information distribution device 1310, transmission terminal 1320, display terminal 1330, and registration terminal 140, and these components are connected to one another through a network.

Information distribution device 1310 includes analysis unit 1311, determination unit 1312, advertisement category 113, registration unit 114, advertisement DB 115, generation unit 1316, and output unit 1318.

Transmission terminal 1320 collects sound of a speech of a speaker through a microphone or the like and transmits the sound to analysis unit 1311 of information distribution device 1310.

Display terminal 1330 is a terminal for displaying advertisement information generated by information distribution device 1310, and is a display device such as a large display.

Registration terminal 140 is a terminal with which an advertising agent registers the advertisement information on information distribution device 110, and is a display device such as a personal computer and a smartphone.

In information distribution system 1300, what is different from information distribution system 100 described with reference to FIG. 1 and information distribution system 1200 described with reference to FIG. 12 is that the content server is replaced by transmission terminal 1320, that analysis unit 1311, determination unit 1312, generation unit 1316, and output unit 1318 of information distribution device 1310 are different, and that information content DB is not provided because generation unit 1316 does not generate the advertisement display scenario.

Analysis unit 1311 obtains, as voice, the speech of the speaker through transmission terminal 1320. Analysis unit 1311 immediately converts the obtained voice into a text by using a speech recognition technology. The voice is converted into a text in a unit of a voice length which the speaker can speak in one breath. Analysis unit 1311 extracts a keyword from the text. Here, the keyword is a characteristic word in the text. Analysis unit 1311 immediately informs determination unit 1312 of the extracted keyword. A display time is not given to determination unit 1312.

In the present exemplary embodiment, different from the first exemplary embodiment and the second exemplary embodiment, the process is performed concurrently with the speech; thus, the display time is not necessary.

Determination unit 1312 determines a category for the keyword given from analysis unit 1311 by using advertisement category 113. Determination unit 1312 informs generation unit 1316 of the keyword and the category of the keyword.

Generation unit 1316 obtains the advertisement information stored in advertisement DB 115, based on the keyword and the category of the keyword given from determination unit 1312, and immediately informs output unit 1318 of the advertisement information.

Output unit 1318 outputs, immediately after the keyword is spoken, the advertisement information in conjunction with the keyword contained in the speech of the speaker to display terminal 1330, for example, disposed in the vicinity of the speaker.

### [3-2. Advantageous Effect, etc.]

As described above, an information distribution device of the present exemplary embodiment includes: an analysis unit configured to extract a text from voice content and configured to extract a keyword from the extracted text; an advertisement DB configured to store advertisement information in association to one of a plurality of advertisement categories; a determination unit configured to determine a category, from the plurality of advertisement categories, for the keyword; a generation unit configured to extract, from the advertisement DB, advertisement information corresponding to the category determined by the determination unit; and an output unit configured to output the advertisement information.

With this arrangement, even in a case of audio content being generated in real-time, it is possible to immediately display advertisement information highly related to the content.

What is claimed is:

1. An information distribution device comprising:
an analysis unit configured to extract a keyword and a display end time of the keyword from a text related to content;
an advertisement DB (Data Base) configured to store advertisement information in association to one of a plurality of advertisement categories;
a determination unit configured to determine a category, from the plurality of advertisement categories, for the keyword;
a generation unit configured to extract, from the advertisement DB, advertisement information corresponding to the category determined by the determination unit, and configured to generate information content in conjunction with the content by setting a display start time of the extracted advertisement information to a time equal to or later than the display end time; and
an output unit configured to output the information content.

2. The information distribution device of claim 1, wherein the text is a caption text.

3. The information distribution device of claim 1, wherein
the content is audio content, and
the analysis unit extracts a text from the audio content, and extracts the keyword and the display end time of the keyword from the extracted text.

4. An information distribution method comprising:
extracting a keyword and a display end time of the keyword from a text related to content;
determining a category for the keyword from a plurality of advertisement categories;
extracting advertisement information corresponding to the determined category from an advertisement DB in which advertisement information is stored in association to one of the plurality of advertisement categories;
generating information content in conjunction with the content by setting a display start time of the extracted advertisement information to a time equal to or later than the display end time; and
outputting the information content.

5. A non-statutory computer-readable recording medium storing a program which causes a computer to execute the information distribution method of claim 4.
